(19) United States
(12) Patent Application Publication
(10) Pub. No.: US 2010/0118521 A1
(43) Pub. Date: May 13, 2010

(54) ILLUMINATED WINDOW

(75) Inventors: Joseph H.A.M. Jacobs, Eygelshoven (NL); Dirk Hente, Wuerselen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/598,117

(22) PCT Filed: Apr. 28, 2008
(86) PCT No.: PCT/IB2008/051623

§ 371 Date: Oct. 29, 2009

(30) Foreign Application Priority Data
May 3, 2007 (EP) 07107417.3

(51) Int. Cl. F21V 33/00

(52) U.S. Cl. 362/147

(57) ABSTRACT

The invention relates to an illuminated window (1) comprising a lighting device (30) connected to a transparent pane (11) and a daylight shielding device, for example a Venetian blind (20). The lighting device (30) may particularly comprise OLEDs (31) that typically cover the whole area of the pane (11). The daylight shielding device (20) is optionally disposed between the first pane (11) and an additional pane (12).

### FILED OF THE INVENTION

The invention relates to an illuminated window comprising a transparent pane and a daylight shielding device.

### BACKGROUND OF THE INVENTION

The DE 103 44 213 A1 discloses a Venetian blind with a plurality of parallel lamellae, wherein one side of the lamellae is coated with Organic Light Emitting Diodes (OLEDs). When the lamellae are vertically aligned, the OLEDs can be used to illuminate the interior of a room. A similar device is disclosed in the DE 101 31 598 C1. The attachment of OLEDs with their associated electrical controls to a movable daylight shielding device is however a nontrivial task. Moreover, the OLEDs on the lamellae have a high risk to be damaged during the use of the daylight shielding device.

### SUMMARY OF THE INVENTION

Based on this situation it was an object of the present invention to provide alternative means for illuminating a window, wherein it is desirable that these means are robust and cost-effective.

This object is achieved by an illuminated window according to claim 1. Preferred embodiments are disclosed in the dependent claims.

Generally speaking, an “illuminated window” according to the present invention is intended for filling an opening of arbitrary size and shape in an arbitrary object. In most cases, said opening will be a window-opening or door-opening in a building or a vehicle (e.g. a car, caravan, or train). The illuminated window comprises the following components:
A transparent pane, which is sometimes called “first pane” in the following to distinguish it from further pane(s) in preferred embodiments of the invention. The material of this pane is typically glass or some transparent plastic. The pane is usually a flat sheet, though general three-dimensional shapes are possible, too.
A daylight shielding device for selectively covering the aforementioned pane. As usual, the main purpose of such a device is to prevent sunlight from passing through the pane and/or to prevent people from looking into a room behind the pane. The daylight shielding device may be realized in many ways, for example by (Venetian) blinds, shutters or curtains. The daylight shielding device comprises some mechanism that allows to switch it between a state in which it covers the pane in order to fulfill a shielding function, and a state in which it allows a more or less free view through the pane. Different embodiments of such mechanisms are known in the state of the art. In many cases, the whole daylight shielding device can be moved out of the region of the pane when no shielding function is desired.
A lighting device for selectively emitting light, wherein said device is connected to the pane and covers at least a part of the pane's area. The “connection” to the pane may be direct, i.e. the lighting device may be attached to the surface of the pane, or indirect, i.e. it may be connected to the pane via intermediate components like a window frame.

The described illuminated window has several advantages. First, the pane provides a solid base on which the lighting device can readily be mounted. As the lighting device covers at least a part of the pane's area, it is automatically disposed in a region that is intended and optimally located for providing light to e.g. a room. Finally, the daylight shielding device guarantees—beside its original shielding function—that the light emitted by the lighting device cannot reach regions that shall not be illuminated. Thus the exterior side of a building can for example be protected from an unintended illumination by the interior lights of the building.

The lighting device is preferably transparent. In this case it does not hinder the entrance of light, even if it covers the whole area of the pane, during the day when there is enough ambient light to illuminate a room from the outside.

In a preferred realization, the lighting device comprises at least one Organic Light Emitting Diode (OLED). OLEDs have the advantage that they can be operated at low voltage, have long operational lifetime, and can readily be produced at low costs with large areas and in many colors. For detailed information on OLEDs, reference is made to literature (e.g. Klemens Brunner: “Industrialization of OLEDs for Lighting Applications and Displays”, American Physical Society, APS March Meeting, Mar. 21-25, 2005; Joseph Shinar (ed.): “Organic Light Emitting Devices, A survey”, Springer, 2004). Optionally the lighting device comprises a plurality of OLEDs arranged in a given structure. Thus it is for example possible to realize an array of pixels that allows to represent images if the pixels are controlled appropriately.

When the lighting device is realized with an OLED, the OLED is preferably disposed directly on the pane. Thus a solid structure can be achieved with minimal constructive effort. The OLED may be disposed on any side of the pane, i.e. on its back-side (which is here and in the following by definition the side turned towards the daylight shielding device) or on its front-side. Optionally, OLEDs may be disposed on both sides of the pane.

In another embodiment of an illuminated window with an OLED, the OLED is covered by a transparent carrier, for example a glass pane. This provides an additional protection for the OLED, which is particularly useful if the OLED is disposed on the front-side of the pane which usually faces the interior of a room and which is therefore exposed to contacts with objects (touches leaving fingerprints etc.).

The daylight shielding device has preferably a reflective surface on a side that can be oriented towards the lighting device. The reflective surface can for example be obtained with a light (e.g. white) or a specular coating. Providing the daylight shielding device with a reflective surface has the advantage that light from the lighting device is reflected back and not lost to the outside of the window.

It was already mentioned that the daylight shielding device may be realized in many different ways. In a preferred embodiment, it is realized as a Venetian blind comprising a plurality of parallel lamellae. Such a design has the advantage that interstices can be provided between the lamella through which are rest of light can pass. These interstices can be spread evenly over the whole area of the pane, providing a substantially uniform light distribution.

In the aforementioned case, the angle of the lamellae with respect to the pane can optionally be adjusted. Thus the effectively covered area of the pane can be changed and adapted to the requirements of a user.

In a further development of the invention, the illuminated window comprises an additional or “second” transparent pane extending parallel to the first pane (to which the lighting device is connected). Thus a window with improved thermal insulation properties can be constructed, particularly if there is a vacuum between the two panes.

According to a further development of the aforementioned embodiment, the daylight shielding device is disposed between the first and the second pane when it covers the first pane. Disposing the daylight shielding device between two panes has the advantage that no extra space is needed for the shielding device and that it is optimally protected from dirt and damaging effects.

These and other aspects of the invention will be apparent from and elucidated with reference to the embodiment(s) described hereinafter. These embodiments will be described by way of example with the help of the accompanying drawings in which:

### BRIEF DESCRIPTION OF THE DRAWINGS

FIG. 1 shows schematically an illuminated window according to the present invention in which OLEDs are disposed on the front-side of an interior glass pane;

FIG. 2 shows an alternative embodiment of such an illuminated window in which OLEDs are disposed on the back-side of the interior glass pane.

### DETAILED DESCRIPTION OF EMBODIMENTS

Like reference numbers or numbers differing by integer multiples of 100 refer in the Figures to identical or similar components.

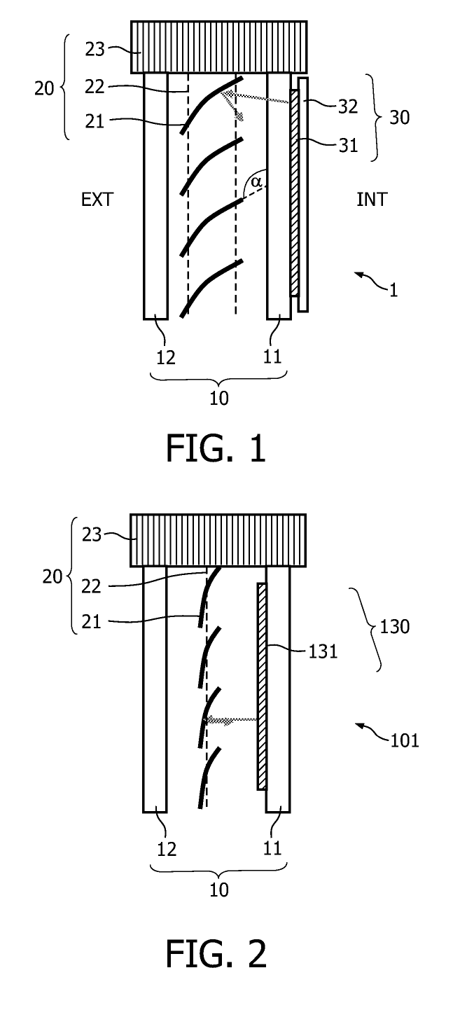

FIG. 1 shows a section through a particular embodiment of an illuminated window 1 according to the present invention. The window 1 may for example be disposed in a window-opening or door-opening of a building (not shown). It typically comprises further components like frames etc. which are known in the state of the art and not shown in the Figure for clarity.

As a first principal component, the illuminated window 1 comprises a window 10 in the narrower sense, which is composed here of a first and a second transparent, flat glass pane 11 and 12, respectively. The two panes 11, 12 may substantially be of the same design and dimensions, wherein the first pane 11 is disposed here at the interior or room-side (INT) of the window-opening, while the second glass pane 12 is located at the exterior or outdoor-side (EXT). The space between the two panes 11, 12 may be evacuated to provide a better thermal insulation.

The illuminated window 1 further comprises a daylight shielding device 20, realized in this example by a Venetian blind with a plurality of parallel lamellae 21 that are attached to strings 22. The strings 22 are fixed with their upper ends to a control and motor unit 23. By pulling both strings 22 synchronously upwards, the lamella 21 can be removed from the space between the two panes 11 and 12, making the window completely transparent. Pulling only one of the strings 22 with respect to the other may be used to change the angle α of the lamellae 21 with respect to the first window pane 11. Thus the effectively covered area of the first pane 11 can be adjusted as desired.

Finally, the illuminated window 1 comprises a lighting device 30, realized here by transparent OLEDs 31 extending over substantially the whole front-side area (which by definition faces the room INT) of the first pane 11. To protect the OLEDs from damage, a further glass pane 32 covers them at the interior side of the window 1.

Organic light emitting diodes provide a high efficiency light source on a large area for a cost effective manufacturing. A typical OLED comprises the following sequence of layers:
a glass substrate;
a first metal or metal-oxide transparent electrode;
organic layers including organic light emitting layers; this could be hole injection layers, electron blocking layers, emitting layers, hole blocking layers, or electron transporting layers;
a second metal or metal-oxide electrode;
a glass substrate.

OLEDs can even be made transparent. This feature is used for the OLEDs 31 that are integrated in the illuminated window 1 shown in FIG. 1.

During the day, sunlight may enter the room-side (INT) through the window 1, and at night one may touch a switch for turning-on the OLEDs 31 and illuminating the room artificially. As the light is emitted in both directions, not only the room (INT), but also the outside (EXT) would be illuminated. This can however be prevented by the Venetian blinds 20 integrated in the window 1. Preferably, the room-side of the lamellae 21 has a reflective coating to redirect light emitted by the OLEDs 31 back into the room.

FIG. 2 shows an alternative embodiment of an illuminated window 101. The difference with respect to the design of FIG. 1 is that the OLEDs 131 are now disposed on the back-side of the first pane 11, i.e. on the side which faces the Venetian blind 20. The first pane 11 therefore protects the OLEDs 131 from contacts with persons or other objects on the room-side of the window 101, allowing to do without the additional glass pane 32 of FIG. 1.

In summary, the main features of the proposed illuminated window system are:
Both OLED and Venetian blinds are integrated in a window.
During the day, sunlight may enter the room through said window. The blinds can be used to block the sunlight completely or partially and/or can be used to guide the sunlight (for example to the ceiling, so a diffuse light is reflected from the ceiling to the room).
At night, the integrated OLED can illuminate the room. The blinds are then used to reflect the light (particularly if a reflective layer is coated on the blinds)
The OLEDs are supplied electrically (driver circuitry).
The blinds can be controlled manually or electrically.
A control unit can be implemented to control the light output of the OLED as well as the blinds (covered area and angle α).

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. An illuminated window (1, 101), comprising
a transparent pane (11);
a daylight shielding device (20) for selectively shielding the pane (11);
a lighting device (30, 130) that is connected to the pane (11) and covers at least a part of its area.

2. The illuminated window (1, 101) according to claim 1,
characterized in that the lighting device (30, 130) is transparent.

3. The illuminated window (1, 101) according to claim 1,
characterized in that the lighting device (30, 130) comprises an OLED (31, 131).

4. The illuminated window (1, 101) according to claim 3,
characterized in that the OLED (31, 131) is disposed on the pane (11).

5. The illuminated window (1, 101) according to claim 3,
characterized in that the OLED (31) is covered by a transparent carrier (32).

6. The illuminated window (1, 101) according to claim 1,
characterized in that the daylight shielding device (20) has a reflective surface on a side that can be oriented towards the lighting device (30, 130).

7. The illuminated window (1, 101) according to claim 1,
characterized in that the daylight shielding device comprises a Venetian blind (20) with a plurality of lamellae (21).

8. The illuminated window (1, 101) according to claim 7,
characterized in that the angle (α) of the lamellae (21) with respect to the pane (11) can be adjusted.

9. The illuminated window (1, 101) according to claim 1,
characterized in that it comprises an additional transparent pane (12) extending parallel to the first pane (11).

10. The illuminated window (1, 101) according to claim 9,
characterized in that the daylight shielding device (20) is disposed between the first pane (11) and the additional pane (12) when it covers the first pane.
